(19) United States
(12) Patent Application Publication
(10) Pub. No.: US 2004/0129047 A1
(43) Pub. Date: Jul. 8, 2004

(54) Tool for treating metallic components with a system for monitoring the operability, and method of monitoring the operability of a tool

(76) Inventors: Dieter Horstmann, Stuttgart (DE); Guido Soell, Urbach (DE)

Correspondence Address: KENYON & KENYON, ONE BROADWAY, NEW YORK, NY, 10004, US

(21) Appl. No.: 10/722,932

(22) Filed: Nov. 26, 2003

(30) Foreign Application Priority Data
Nov. 28, 2002 (DE) 102 55 442.0

(51) Int. Cl. B23Q 17/00; B21D 55/00

(52) U.S. Cl. 72/20.1; 29/407.08

(57) ABSTRACT

In a tool and a method having a system for monitoring the operability of the tool, a shank-like section is provided with a tool section subjected to wear and is equipped with a cavity, to which a pressure medium is admitted for monitoring the operability of the tool, the shank-like section having a predetermined breaking point, and a monitoring device being provided, by which a signal of failure may be generated in the event of a pressure change.

### CROSS-REFERENCE TO RELATED APPLICATIONS

The present application claims priority to Application No. 102 55 442.0, filed in the Federal Republic of Germany on Nov. 28, 2002, which is expressly incorporated herein in its entirety by reference thereto.

### FIELD OF THE INVENTION

The present invention relates to a tool for the treatment of metallic components, e.g., cast components, such as trimming tools for example, and to a method of monitoring the operability of such a tool.

### BACKGROUND INFORMATION

In particular in automated production processes, there is the problem that treatment tools, such as blanking punches or trimming tools, for example, have to be permanently monitored for their operability in order to ensure a smooth sequence of manufacturing processes, in particular in large-scale production. For example, for the production of cast components, such as engine blocks for example, trimming tools in the form of blanking punches are conventional, these trimming tools being provided with a cutting edge in order to remove projecting flash or the casting tool from the cast parts in the automated manufacture of cast parts. Such tools or other tools are subjected to wear in the process until the tool breaks, as a result of which the operability can abruptly no longer be provided for.

In order to avoid impairing the manufacturing process, which is fully automated as a rule, of such components, monitoring systems are conventional in which it can be established by photoelectric barriers and corresponding control units whether a tool is still completely present or whether a tool fracture or damage to the same exists. A disadvantage in this case is that the sensory analysis by photoelectric barriers is susceptible to faults and that, in addition, the tools have to be readily accessible, that is to say they have to be freely accessible at least from one or more sides. This is not the case in the most frequent practical applications.

On the other hand, systems for monitoring the operability of tools of machine tools are conventional in which a crack in or damage to the tool can be monitored by a pressure chamber, to which a pressure medium is admitted, and pressure sensors. Such a system is described, for example, in German Published Patent Application No. 41 07 093, in which a punch press tool is formed with a pressure chamber to which a pressure medium is admitted via a pressure sensor such that a signal can be generated by a control device if the tool is damaged or cracked. Whereas the provision of a cavity for the admission of pressure can be realized in a relatively simple manner in the case of forming tools having a punch of large surface area and a die of complementary shape, such a system for monitoring the operability in cutting tools, such as blanking punches or trimming tools, for example, can only be realized at considerable cost. In this area, it is still necessary to rely on the susceptible photoelectric barriers or manual, visual monitoring of the operability of tools.

It is an aspect of the present invention to provide a tool having a system for monitoring the operability and a method of carrying out such monitoring, by which tool and method effective monitoring of the operability and/or of the presence of the complete tool may be realized in a simple manner from the design point of view.

### SUMMARY

The above and other beneficial aspects of the present invention may be achieved by providing a tool and a method as described herein.

The tool according to an example embodiment of the present invention for the cutting or noncutting treatment of metallic components with a shank-like section has a tool section which is subjected to wear and is provided with a cavity, to which a pressure medium is admitted for monitoring the operability of the tool. The tool includes a monitoring device, by which a signal may be generated in the event of a pressure change. In this manner, the presence and/or the operability of the tool or of its tool cutting edge or tool surface may be checked by the simple monitoring of a pressure change. The tool may also be fitted in complex machine environments without the operability monitoring being impaired. The cavity to which pressure is admitted is located directly in the shank-like tool itself, so that it is not necessary to provide separate pressure cavities, which have to be inserted as additional components in a tool region. The rigidity and the strength of the tool may be scarcely impaired. The monitoring device may have a signal generating device, which is activated as soon as a pressure change above a predetermined limit value is detected. Thus, the perfect functioning of the tool, such as, for example, a blanking punch for the treatment of the flash of cast parts, may be realized in a simple and equally effective manner.

According to an example embodiment of the present invention, the cavity, to which pressure is admitted, in the shank-like tool section is a blind bore. A blind bore may be provided in shank-like tools, for example, as a central bore lengthwise from the rear up to approximately the tip of the tool, that is to say essentially along the longitudinal axis of the tool itself. This permits the provision of a cavity over approximately the entire length of the tool without the strength of the tool being greatly impaired. The blind bore may be realized by simple boring without expensive measures having to be taken during the shaping of the tool.

According to an example embodiment of the present invention, the tool may be designed as an interchangeable unit, and the cavity to which pressure is admitted may have pressure admitted to it by connecting lines. The tool may therefore be exchanged in a simple manner if damage to or fracture of the tool tip or a part of the tool is established. Occurrence of damage is established immediately and may be carried out without expensive repair or assembly operations.

According to an example embodiment of the present invention, the monitoring device may include a pressure switch which reacts at a preset value of a pressure change. This avoids a situation in which even slight pressure changes, as may occur, for example, due to an escape of pressure medium from the connecting point between the tool and the machine unit, have the effect that a lack of operability is detected.

According to an example embodiment of the present invention, the shank-like section has a predetermined breaking point which may ensure that the fracture is complete and the drop in pressure may be easily detected by the monitoring unit. The predetermined breaking point on the shank-like tool may furthermore be realized by a local reduction in diameter at the tool section itself. The reduction in diameter may include a ring-like notch in the vicinity of the tool tip, or a complete reduction in circumference over a certain section in the vicinity of the tool tip. By simple shaping of the tool, the predetermined breaking point for the function monitoring system according to the present invention may thus be provided.

According to an example embodiment of the present invention, the tool is a blanking punch which may be used as a trimming tool for the production of cast parts and has a cutting edge. The tool is provided with a predetermined breaking point reduced in diameter relative to the shank section. In this case, the predetermined breaking point may be realized in the vicinity of the cutting edge, that is to say, for example, as a neck-like constriction of the tool diameter between the shank and the end cutting-edge part. In particular, the trimming treatment of cast parts by blanking punches may lead to fracture of the tool, as a result of which such manufacturing processes have hitherto not been able to be carried out fully automatically and have always required monitoring by the complicated devices or by the machine operator. The example embodiment of the present invention may permit for the first time effective monitoring in a fully automatic manner.

According to an example embodiment of the present invention in this respect, the tool is a mandrel for shaping metal sheets. Such shaping tools, such as mandrels, etc., may be exposed to the risk of fracture and thus to an abrupt failure of the machine tool. Here, the admission of pressure according to an example embodiment of the present invention by a blind bore allows a check to be carried out for the presence of the tool and for the complete operability of the tool in a very simple manner without the tool environment having to be equipped in a special manner or having to be provided with special devices.

The method according to an example embodiment of the present invention for monitoring the operability of a treatment tool, e.g., for the treatment of cast parts, which tool is provided with a shank-like section and a cavity to which a pressure medium may be admitted, the function of the tool being monitored via a pressure change, includes:

a) admission of compressed air to a blind bore in the tool; and

b) generation of a signal if a preset value of a pressure change is exceeded in the event of a fracture of the tool.

By simple use of a blind bore to which a pressure medium, such as a pressure liquid or compressed air, for example, may be admitted, and by the generation of a warning signal or control signal if a preset pressure change value is exceeded, the operability of the tool may thus be effectively checked by the monitoring method of the example embodiment of the present invention. Design modifications with regard to the tool environment may be scarcely required in order to carry out the method. The method may also be carried out in critical environmental conditions in which the use of photoelectric barriers, for example, for detecting tool operability is not possible.

According to an example embodiment of the method according to the present invention, a plurality of tools of a treatment complex, such as, for example, a treatment line having a plurality of tool parts, is monitored with a single pressure switch which is coupled to a control unit for generating a warning signal if one of the tools fails. With only a single monitoring unit and a single pressure switch or pressure sensor, a complete manufacturing unit having a multiplicity or plurality of tools may thus be monitored for the operability of the same.

Further aspects and features of example embodiments of the present invention may be gathered from the description below, in which the present invention is described and explained in more detail with reference to exemplary embodiments illustrated in the attached drawing.

### BRIEF DESCRIPTION OF THE DRAWINGS

FIG. 1 is a schematic cross-sectional view of an example embodiment of a blanking punch for carrying out trimming treatment on cast components according to the present invention.

FIG. 2 is a schematic view of an exemplary circuit arrangement of operability monitoring according to an example embodiment of the present invention.

### DETAILED DESCRIPTION

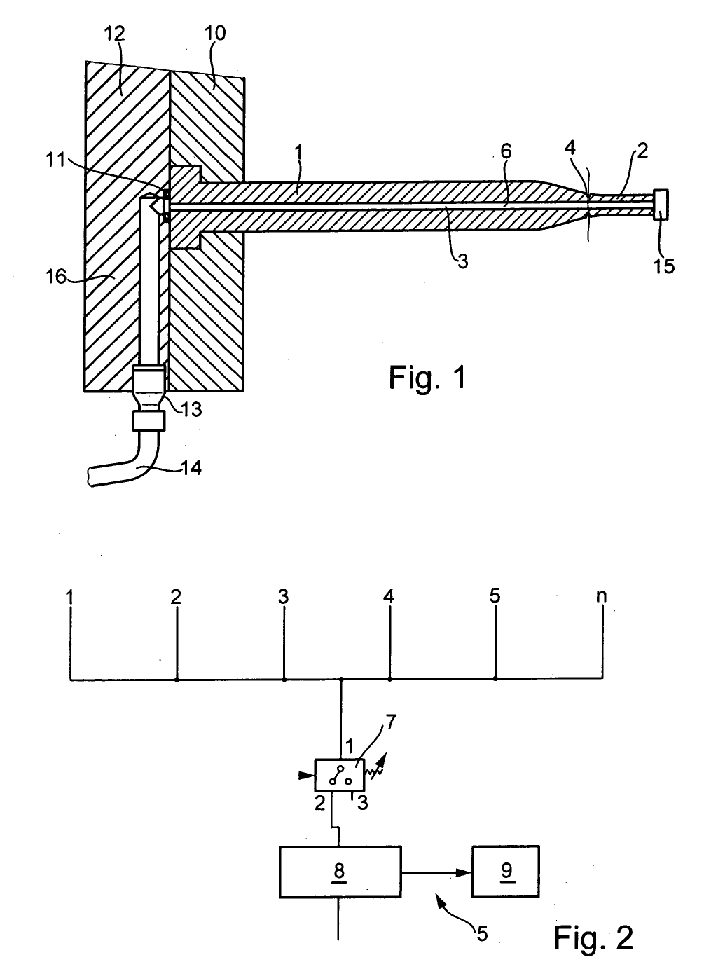

An exemplary embodiment according to the present invention of a blanking punch having a cutting edge for trimming cast components is illustrated in a cross-sectional view in FIG. 1. The tool is reproduced here by way of example in the form of a trimming tool or a blanking punch which has a cutting edge 15 and a shank-like tool section 1. The shank-like section 1, by an annular shoulder and a correspondingly shaped recess, is clamped in place in a retaining plate 10 of a machine tool device via a fastening plate 12. A connecting passage 16 for compressed air is provided in the fastening plate 12 and is supplied with compressed air via a compressed-air line 14 which is fastened to the fastening plate 12 by a plug 13.

The tool part itself is provided with a central blind bore 6 which forms a cavity 3 for the compressed air. Compressed air is admitted to the cavity 3 via the compressed-air line 14 and the compressed-air passage 16, a sealing ring 11 preventing an escape in the connecting plane between the fastening plate 12 and the retaining plate 10. The shank-like tool is provided with a cutting edge 15 at its front end. Furthermore, the tool section 2 is provided with a predetermined breaking point 4, which is provided close to the cutting edge 15 as a region reduced in diameter. The predetermined breaking point 4 is provided, for example, as a ring-shaped notch on the cylindrical shank section 1 of the tool. As soon as the cutting edge 15 or a part of the cutting edge 15 breaks off during treatment of a cast part, etc., a failure or an impairment of the operability of the tool is established by a pressure change on account of an escape of pressure medium from the cavity 3. In this manner, effective monitoring of the functioning of the tool may be ensured in a very simple manner from the design point of view and without additional outlay in terms of construction.

A circuit diagram of an exemplary embodiment of the method according to the present invention is illustrated in FIG. 2. A plurality of tools, such as, for example, blanking punches, shaping mandrels, etc., are connected via a collecting line to a single pressure switch 7, which in turn is connected to a monitoring device 5 in the form of a control unit 8 and a signal output unit 9. In this manner, the operability may be controlled for a multiplicity of treatment tools with one and the same monitoring device 5. It is not necessary to equip each tool 1, 2, 3 to n with a separate pressure switch and a separate monitoring unit.

All of the features presented in the description and illustrated in the drawings may be provided, both individually and in any combination with one another.

What is claimed is:

1. A tool for at least one of cutting and noncutting treatment of a metallic component, comprising:
a shank-shaped section including a tool section subject to wear and a cavity;
an arrangement configured to admit a pressure medium to the cavity to monitor operability of the tool; and
a monitoring device configured to generate a signal in accordance with a pressure change in the pressure medium.

2. The tool according to claim 1, wherein the metallic component includes a cast component.

3. The tool according to claim 1, wherein the cavity includes a blind bore in the shank-shaped section.

4. The tool according to claim 1, wherein the tool is configured as an interchangeable unit, the arrangement configured to admit the pressure medium including an arrangement configured to admit compressed air to the cavity by connecting lines.

5. The tool according to claim 1, wherein the monitoring device includes a pressure switch configured to react at a preset value of a pressure change.

6. The tool according to claim 1, wherein the shank-shaped section includes a predetermined breaking point.

7. The tool according to claim 6, wherein the breaking point is configured as a local reduction in diameter at the tool section.

8. The tool according to claim 1, wherein the tool section is configured as a blanking punch as a trimming tool for a cast part, the tool section including a cutting edge and a predetermined breaking point reduced in diameter relative to the shank-shaped section.

9. The tool according to claim 1, wherein the tool section includes a mandrel configured to shape a metal sheet.

10. A method of monitoring operability of a tool for at least one of cutting and noncutting treatment of a component, the tool including a shank-shaped section and a cavity to which a pressure medium is admittable, comprising:
admitting compressed air to a blind bore in the tool;
generating a signal if a preset value of a pressure change of the compressed air is exceeded in accordance with a fracture of the tool; and
monitoring a function of the tool in accordance with the pressure change.

11. The method according to claim 10, wherein the component includes a cast component.

12. The method according to claim 10, further comprising:
monitoring a plurality of tools of a treatment complex in accordance with a single pressure switch coupled to a control unit;
generating a warning signal by the control unit via a signal generating device in accordance with a failure of at least one of the plurality of tools.

13. A tool for at least one of cutting and noncutting treatment of a metallic component, comprising:
a shank-shaped section including a tool section subject to wear and a cavity;
means for admitting a pressure medium to the cavity for monitoring operability of the tool; and
monitoring means for generating a signal in accordance with a pressure change in the pressure medium.
